(19) United States
(12) Patent Application Publication
(10) Pub. No.: US 2008/0085046 A1
(43) Pub. Date: Apr. 10, 2008

(54) Detailed identification method for articles

(76) Inventors: Yen-Chieh Lee, Tainan City (TW); Raymond R. Chen, Taichung City (TW); Pen-Tsung Huang, Kaohsiung (TW); Ming-Feng Shih, Kaohsiung (TW); Jin-Tang Fang, Kaohsiung (TW); Chung-Min Huang, Kaohsiung (TW); Cheng-Chi Wu, Kaohsiung (TW); Minh-Lun Hsieh, Kaohsiung (TW)

Correspondence Address: Hershkovitz & Associates, LLC, 2845 Duke Street, Alexandria, VA, 22314, US

(21) Appl. No.: 11/542,254

(22) Filed: Oct. 4, 2006

(51) Int. Cl. G06K 9/00

(52) U.S. Cl. 382/137; 382/100

(57) ABSTRACT

A detailed identification method for articles has an image-taking step and a comparison step. The image-taking step includes acts of using a portable identification device having a close-up lens and a screen to take a detailed image of an undistinguishable article and displaying the detailed image on the screen with an enlarged size. The comparison step includes acts of recalling a detailed image of a legal article from a database and displaying the detailed image on the screen of the portable identification device with an enlarged size. The two detailed images are displayed on the same screen so a user can clearly compare the detailed images to judge whether the undistinguishable article is a fake. The detailed identification method for articles has mobility and can be conveniently and extensively used.

### BACKGROUND OF THE INVENTION

1. Field of the Invention

The present invention relates to a detailed identification method for articles, and more particularly to a detailed identification method for articles, which has mobility and can be extensively used.

2. Description of Related Art

Due to the high development of technology, most articles such as products, merchandise, currencies or the like are precisely manufactured to have texture with invisible detailed features to prevent counterfeiting. Thus, distinguishing between a legal article and a fake one is hard for human eyes, which may bring loss of economy or even cause an unnecessary disputation in transaction just because of an erroneous judgement.

To identify detailed features on texture and to distinguish a fake article from a legal one, an identification machine is developed. However, the identification machine is heavy and bulky so that the identification machine has to be placed in a fixed position and is immobile and hard to be carried by a user when he/her shop for articles. To verify an undistinguishable article is legal or fake, the user has to take the undistinguishable article to a place where the identification machine is set and then uses the identification machine to take an image of the undistinguishable article and recall an image file of a legal article from a built-in database in the identification machine to compare the two images to acquire a conclusion. So using the identification machine to identify an undistinguishable article is very inconvenient.

Additionally, the identification machine is expensive. With immobility and high price, the identification is unable to be expensively used.

### SUMMARY OF THE INVENTION

The primary objective of the present invention is to provide a detailed identification method for articles to mitigate or obviate the aforementioned problems.

The detailed identification method for articles comprises an image-taking step and a comparison step. The image-taking step includes acts of using a portable identification device having a close-up lens and a screen to take a detailed image of an undistinguishable article and displaying the detailed image of the undistinguishable on the screen with an enlarged size.

The comparison step includes acts of recalling a detailed image of a legal article from a database and displaying the detailed image of the legal article on the screen of the portable identification device with an enlarged size to display the detailed image of the undistinguishable article and the detailed image of the legal article on the same screen for a user to easily and clearly compare the detailed images to determine whether the undistinguishable article is a fake.

Because of utilizing the portable identification device, the detailed identification method for articles is mobile and can be conveniently and extensively used to easily and clearly distinguish a fake article from a legal one.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of steps of a detailed identification method for articles in accordance with the present invention;

FIG. 2 is a front view of a portable identification device fitting with the detailed identification method for articles in FIG. 1;

FIG. 3 is a front view of the portable identification device fitting with the detailed identification method for articles in FIG. 1 with an detailed image of an undistinguishable article and an detailed image of a legal article being juxtaposed together on a screen of the portable identification device, wherein the undistinguishable article is legal;

FIG. 4 is a front view of the portable identification device fitting with the detailed identification method for articles in FIG. 1 with an detailed image of an undistinguishable article and an detailed image of a legal article being juxtaposed together on the screen of the portable identification device, wherein the undistinguishable article is fake;

FIG. 5 is a side view of the portable identification device fitting with the detailed identification method for articles in FIG. 1;

FIG. 6 is a front view of the portable identification device fitting with the detailed identification method for articles in FIG. 1 with an detailed image of an undistinguishable article being overlapped with an detailed image of a legal article on the screen of the portable identification device;

FIG. 7 is a block diagram of a first embodiment of the portable identification device fitting with the detailed identification method for articles in FIG. 1;

FIG. 8 is a block diagram of a second embodiment of the portable identification device fitting with the detailed identification method for articles in FIG. 1;

FIG. 9 is a block diagram of a third embodiment of the portable identification device fitting with the detailed identification method for articles in FIG. 1; and

FIG. 10 is a block diagram of a forth embodiment of the portable identification device fitting with the detailed identification method for articles in FIG. 1.

### DETAILED DESCRIPTION OF THE PREFERRED EMBODIMENT

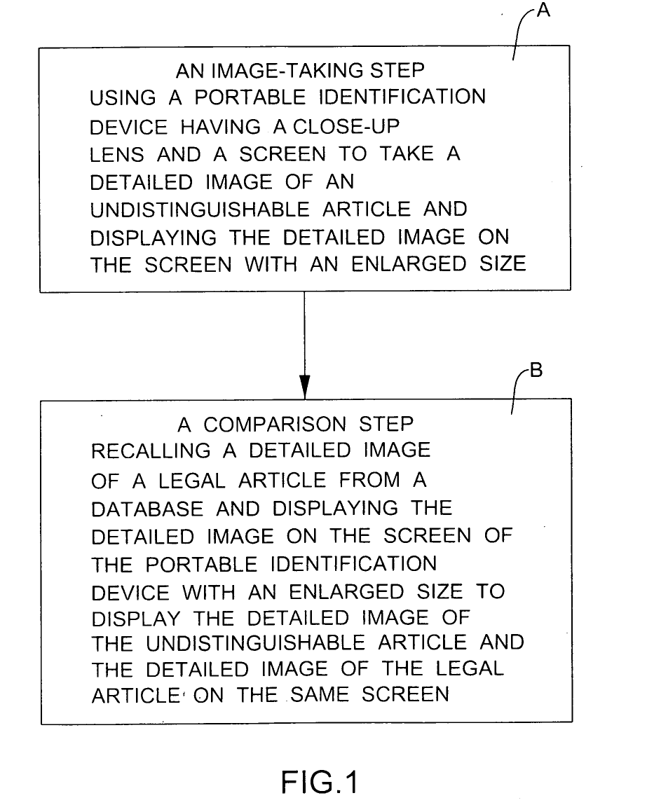

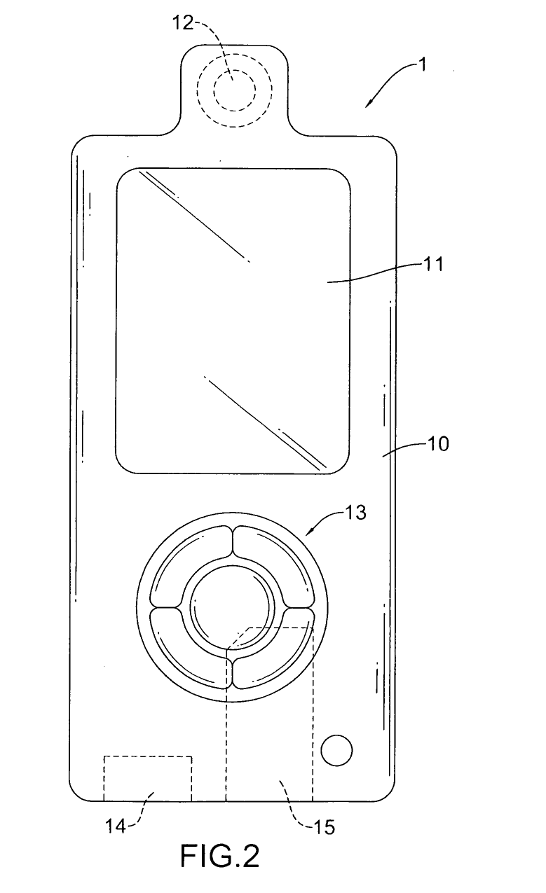

With reference to FIGS. 1-4 and 6, a detailed identification method for articles in accordance with the present invention comprises an image-taking step (A) and a comparison step (B).

The image-taking step (A) includes acts of using a portable identification device (1) having a body (10), a close-up lens (12) and a screen (11) to take a detailed image (30, 40, 60) of an undistinguishable article and displaying the detailed image (30, 40, 60) on the screen (11) with an enlarged size.

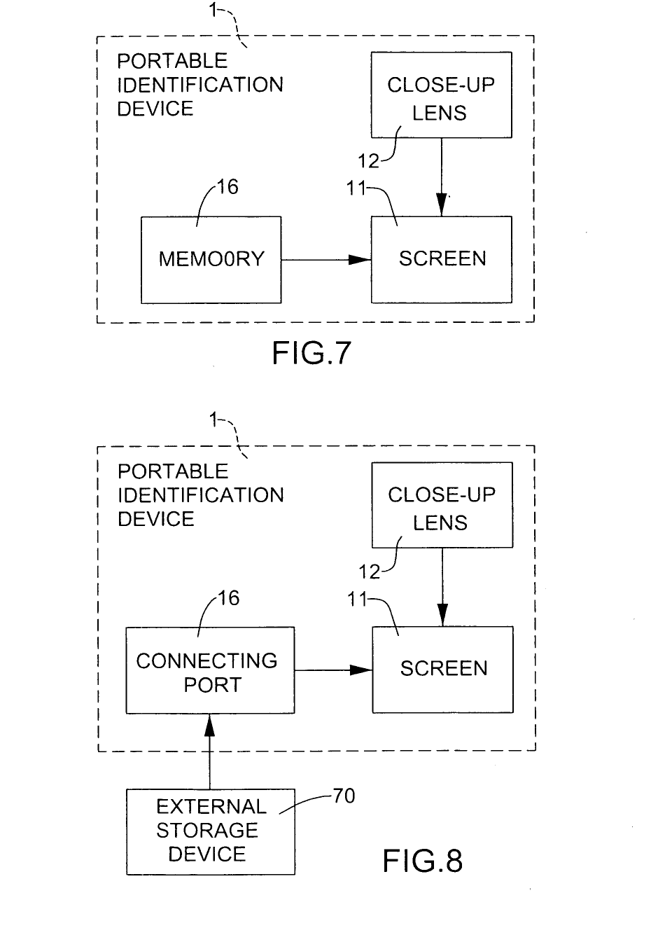

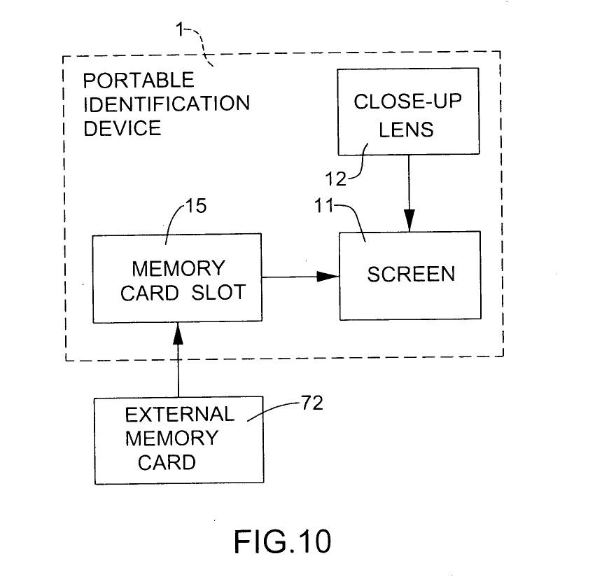

With further reference to FIGS. 7-10, the portable identification device (1) may further have a memory (16), a setting key assembly (13), a connecting port (14), a wireless signal receiver (17) and a memory card slot (15). The memory (16) is mounted in the body (10) of the portable identification device (1). The setting key assembly (13) is mounted on the body (10) of the portable identification device (1). The wireless signal receiver (17) is mounted in the body (10) of the portable identification device (1). The connecting port (14) is mounted in the body (10) of the portable identification device (1). The memory card slot (15) is defined in the body (10) of the portable identification device (1) for receiving an external memory card (72) with a built-in expanded database to expand an amount of usable data.

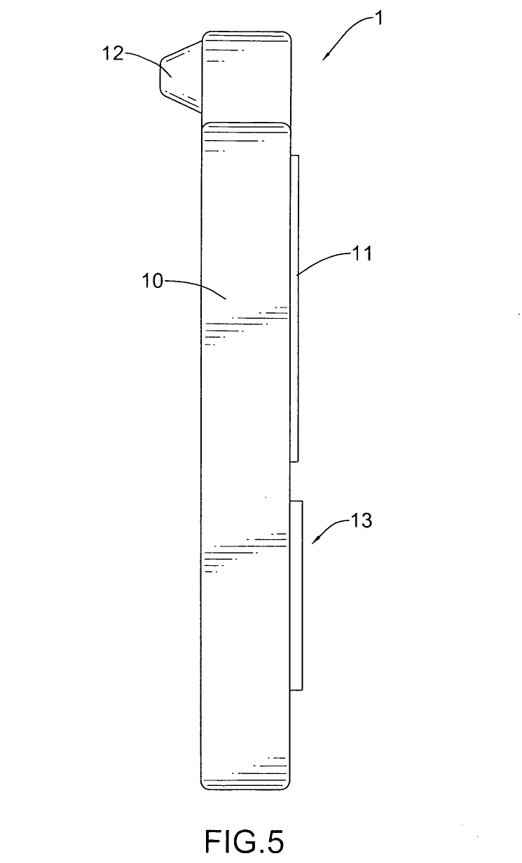

With further reference to FIG. 5, the close-up lens (12) may be replaceable to adjust a zoom in/out magnification and may face frontward to make image-taking conveniently for a user.

The comparison step (B) includes acts of recalling a detailed image (20, 50) of a legal article from a database and displaying the detailed image (20, 50) of the legal article on the screen ( 11) of the portable identification device (1) with an enlarged size to display the detailed image (30, 40, 60) of the undistinguishable article and the detailed image (20, 50) of the legal article on the same screen (11). Therefore, the user can easily and clearly compare the detailed image (30, 40, 60) of the undistinguishable article with the detailed image (20, 50) of the legal article to judge the undistinguishable article is legal or fake.

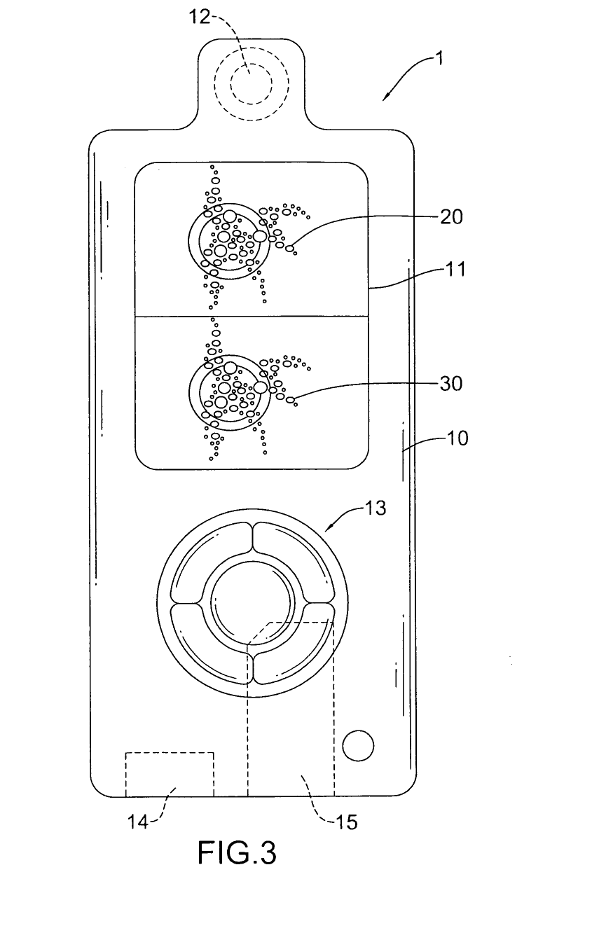

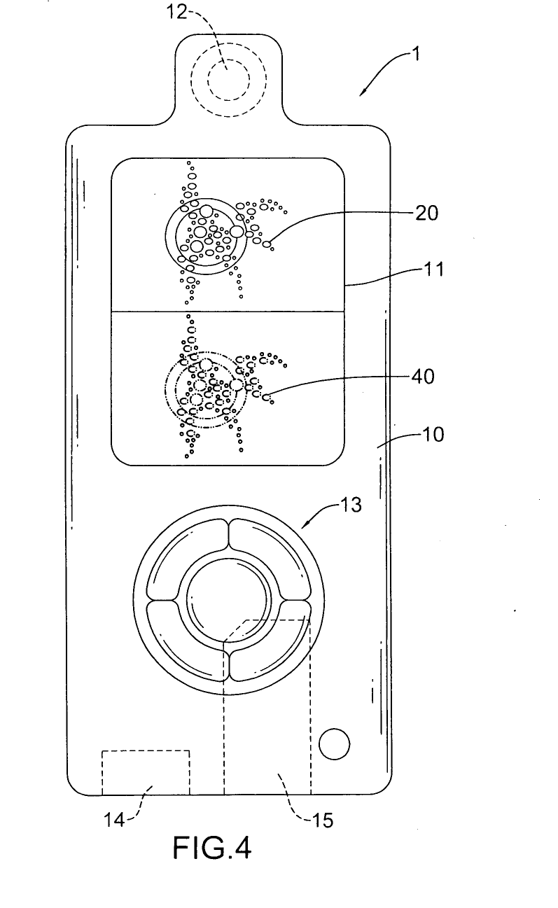

With further referenced to FIGS. 3-4, the detailed image (30, 40) of the undistinguishable article may be juxtaposed with the detailed image (20) of the legal article on the same screen (11) to be conveniently compared. The detail image (30, 40) of the undistinguishable article and the detailed image (20) of the legal article may be juxtaposed in a row or in a column to be compared.

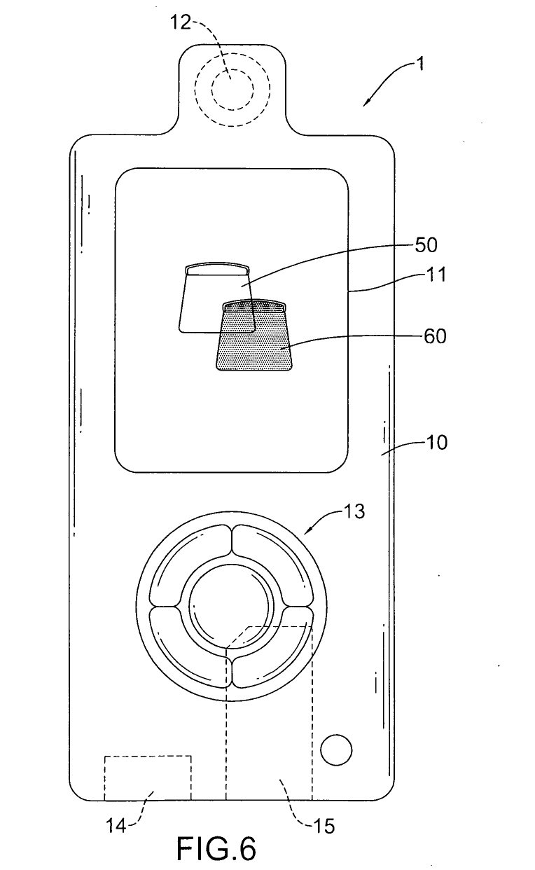

With further referenced to FIG. 6, the detailed image (60) of the undistinguishable article may be overlapped with the detailed image (50) of the legal article on the same screen to be further conveniently compared.

The database may be implemented in several ways.

With further reference to FIG. 7, in a first embodiment of the database, the database is built in the memory (16) of the portable identification device (1) for the user to directly and instantly recall the detailed image (20, 50) of the legal article from the memory (16) via the setting key assembly.

With further reference to FIG. 8, in a second embodiment of the database, the database is built in an external storage device (70). Thus, the comparison step (B) further includes an act of connecting the external storage device (70) to the connecting port (14) of the portable identification device (1) to recall the detailed image (20, 50) of the legal article from the database in the external storage device (70).

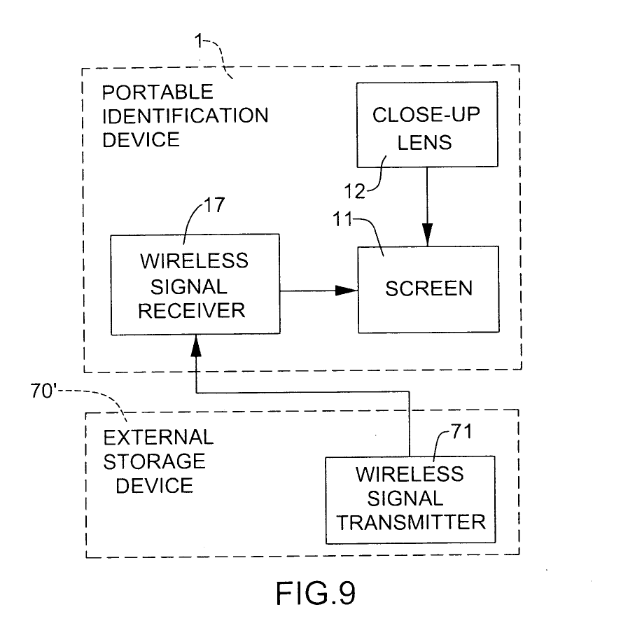

With further reference to FIG. 9, in a third embodiment of the database, the database is built in an external storage device (70′) with a wireless signal transmitter (71). Thus, the comparison step (B) further includes an act of using the wireless signal receiver (17) to receive data transmitted from the wireless signal transmitter (71) to recall the image (20, 50) of the legal article from the database in the external storage device (70′).

With the portable identification device (1), the detailed identification method for articles has mobility to be conveniently and extensively used to easily distinguish a fake article from a legal one.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A detailed identification method for articles comprising:
an image-taking step including acts of
using a portable identification device having a body, a close-up lens and a screen to take a detailed image of an undistinguishable article; and
displaying the detailed image of the undistinguishable on the screen with an enlarged size; and
a comparison step including acts of
recalling a detailed image of a legal article from a database; and
displaying the detailed image of the legal article on the screen of the portable identification device with an enlarged size to display the detailed image of the undistinguishable article and the detailed image of the legal article on the same screen.

2. The detailed identification method for articles as claimed in claim 1, wherein
the portable identification device further has a connecting port;
the database is built in an external storage device; and
the comparison step further includes an act of connecting an external storage device to the connecting port of the portable identification device to recall the detailed image of the legal article from the database in the external storage device.

3. The detailed identification method for articles as claimed in claim 1, wherein
the portable identification device further has a wireless signal receiver;
the database is built in an external storage device with a wireless signal transmitter; and
the comparison step further includes an act of using the wireless signal receiver to receive data transmitted from the wireless signal transmitter to recall the image of the legal article from the database in the external storage device.
